(19) United States
(12) Patent Application Publication
(10) Pub. No.: US 2001/0004475 A1
(43) Pub. Date: Jun. 21, 2001

(54) Methods of providing article with corrosion resistant coating and coated article

(75) Inventors: William Patrick Allen, Portland, CT (US); Walter E. Olson, Vernon, CT (US); Dilip M. Shah, Glastonbury, CT (US); Alan David Cetel, West Hartford, CT (US)

Correspondence Address: Pratt & Whitney, Patent Department, Mail Stop 132-13, 400 Main Street, East Hartford, CT, 06108, US

(73) Assignee: United Technologies Corporation

(21) Appl. No.: 09/736,545

(22) Filed: Dec. 13, 2000

Related U.S. Application Data
(62) Division of application No. 09/467,202, filed on Dec. 20, 1999.

(51) Int. Cl. B05D 3/02

(52) U.S. Cl. 427/446; 427/383.3; 427/248.1

(57) ABSTRACT

According to the invention, an article that is exposed to high temperatures, e.g.. over 1000° C. during operation is disclosed. In one embodiment, a method for a gas turbine engine includes a directionally solidified metallic substrate, e.g., a superalloy, which defines an airfoil, a root and a platform located between the blade and root. The platform has an underside adjacent the root, and a corrosion resistant overlay coating such as an MCrAlY or a noble metal containing aluminide or corrosion inhibiting ceramic is located on portions or the blade not previously covered with such coatings, e.g., the underside of the platform and the neck. The applied coating prevents corrosion and stress corrosion cracking of blade in these regions. Where the airfoil is also coated, the airfoil coating may have a composition different from that of the coating on the underplatform surfaces.

### CROSS REFERENCE TO RELATED APPLICATIONS

Some of the subject matter disclosed herein is also disclosed in commonly owned pending applications Ser. Nos. entitled “Article Having Corrosion Resistant Coating” by Allen, Olson, Shah and Cetcl [Attorney Docket No. EH-10365], entitled “Article Having Corrosion Resistant Coating” by Allen and Olson, filed on even date herewith and expressly incorporated by reference herein [Attorney Docket No. EH-10379], and entitled “Article Having Corrosion Resistant Coating” by Shah and Cetel [Attorney Docket No. EH-10384].

### BACKGROUND OF THE INVENTION

The present invention relates generally to coatings for corrosion protection, and more particularly to methods of applying such coatings to articles.

Gas turbine engines are well developed mechanisms for converting chemical potential energy, in the form of fuel, to thermal energy and then to mechanical energy for use in propelling aircraft, generating electric power, pumping fluids etc. One of the primary approaches used to improve the efficiency of gas turbine engines is the use of higher operating temperatures. In the hottest portion of modern gas turbine engines (i.e., the primary gas flow path within the engine turbine section), turbine airfoil components, cast from nickel or cobalt based alloys, are exposed to gas temperatures above their melting points. These components survive only because cooling air is passed through a cavity within the component. The cooling air circulates through this cavity reducing component temperature and exits the component through holes in the component, where it then mixes with the hot gasses contained within the primary flow path. However, providing cooling air reduces engine efficiency.

Accordingly, there has been extensive development of coatings for gas turbine hardware. Historically, these coatings have been applied to improve oxidation or corrosion resistance of surfaces exposed to the turbine gas path More recently, thermal barrier coating have been applied to internally cooled components exposed to the highest gas path temperatures so that the amount of cooling air required can be substantially reduced. Since coatings add weight to a part and debits fatigue life, application of the coating is intentionally limited to those portions of the component for which the coating is necessary to achieve the required durability. In the case of rotating parts such as turbine blades, the added weight of a coating adds significantly to blade putt, which in turn requires stronger and/or heavier disks, which in turn require stronger and/or heavier shafts, and so on. Thus there is added motivation to restrict use of coatings strictly to those portions of the blade, e.g., typically the primary gas path surfaces, where coatings are absolutely required.

With increasing gas path temperatures, turbine components or portions of components that are not directly exposed to the primary turbine gas path may also exposed to relatively high temperatures during service, and therefore may also require protective coatings. For example, portions of a turbine blade that are not exposed to the gas path (such as the underside of the platform, the blade neck, and attachment serration) can be exposed to temperatures in excess of 1200 F. during service. These blade locations are defined at 18 and 19 in FIG. 1. It is expected that the temperatures these portions of the blade are exposed to will continue to increase as turbine operating temperatures increase.

The present invention describes application of a corrosion-resistant coating to portions of turbine blades not previously coated and not directly exposed to the hot gas stream to improve component durability.

It is another object of the invention to provide a corrosion-resistant crating to prevent stress corrosion cracking on portions of components that are not directly exposed to a hot gas stream.

It is yet another object of the invention to provide such a coating to protect against stress corrosion cracking of moving components such as turbine blades in regions under the blade platform.

### SUMMARY OF THE INVENTION

According to one aspect of the invention, improved durability of gas turbine blades is achieved through application of corrosion resistant coatings. A turbine blade for a gas turbine engine, typically composed of a directionally solidified nickel-based superalloy, including an airfoil, a root and a platform located between the blade airfoil and root. The platform has an underside adjacent the blade neck, and the blade neck is adjacent to the blade root.

In one aspect of this invention, a corrosion resistant overlay coating such as an MCrAlY (M typically consisting of nickel and/or cobalt) is applied to the underside of the platform and portions of the blade neck. To maximize corrosion protection, the coating should preferably be composed of about 20-40% Cr and 5-20% Al. The presence of this coating improves component life by preventing blade corrosion by the salt accumulating on regions of the blade shielded from direct exposure to the gas path. An additional benefit of the applied coating is the prevention of blade stress corrosion cracking. The corrosion resistant overlay coating prevents corrosion and/or stress corrosion cracking by acting as a barrier between the salt and nickel-based alloy component. The coating system may include an aluminide or platinum aluminide coating layer either between the substrate and the MCrAlY layer or over the MCrAlY layer.

According to another aspect, a corrosion resistant aluminide coating such as a platinum aluminide coating is applied to the underside of the platform and portions of the blade neck. To maximize corrosion protection, the coating should possess between about 30 - 45 wt. % platinum, balance aluminum. Additional coatings may be applied over the aluminide, e.g., a metallic overlay or a ceramic insulating layer.

According to yet another aspect of this invention, a ceramic material such as a stabilized zirconia is applied to the underside of the platform and portions of the blade neck, preferably by plasma spray. Coatings such as metallic coatings may be applied between the substrate and the ceramic.

### BRIEF DESCRIPTION OF THE DRAWINGS

FIG. 1 is an illustration of a superalloy article in accordance with the present invention.

FIG. 1a is a schematic illustration of a coating applied to the article of FIG. 1.

FIG. 2 is representative of the corrosion life improvement achieved with overlay coating.

FIG. 3 is a schematic illustration another embodiment of the present invention.

FIG. 4 is a schematic illustration of still another embodiment of the present invention.

FIG. 5 is a schematic illustration of another coating applied to an article similar to FIG. 1.

FIG. 6 is representative of the corrosion life improvement achieved with an inventive aluminide coating of FIG. 5.

FIG. 7 is a schematic illustration of still another coating applied to an article similar to FIG. 1.

FIG. 8 is a schematic illustration another embodiment of the present invention.

### DETAILED DESCRIPTION OF THE PREFERRED EMBODIMENTS

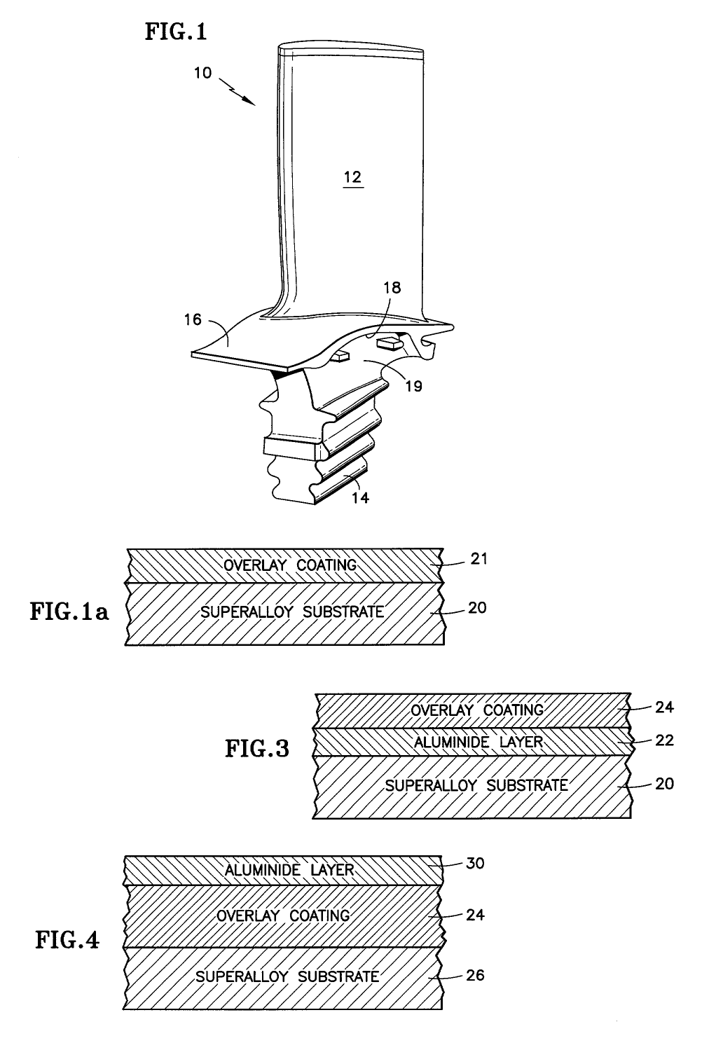

As illustrated in FIG. 1, a turbine blade composed of a superalloy material and incorporating the present invention is illustrated generally by the reference numeral 10. The turbine blade includes an airfoil 12, a serrated blade root 14 (used to attach the blade to the rotatable turbine disk) and a platform 16 located between the airfoil and serrated root. The region between the underside of the blade platform 18 and the root is referred to as the neck 19. Typically, turbine blades (and other gas turbine engine components) are composed of a directionally solidified nickel-based alloy, e.g., consisting of a single crystal or with multiple columnar grains oriented parallel to the direction of growth. Typical compositions of such alloys are shown in Table 1. Exemplary U.S. Pat. Nos. describing columnar and single crystal and directionally solidified alloys include 4,209,348; 4,643,782; 4,719,080 and 5,068,084, each of which is expressly incorporated by reference herein. Cooling holes which may be positioned on one or more portions of a turbine blade, may be provided for flowing cooling air over the specific portions of the airfoil during operation, as is known generally in the art.

TABLE 1
COMPOSITION OF COLUMNAR AND SINGLE CRYSTAL ALLOYS

| Alloy | Type | Ni | Co | Cr | Al | Mo | Ta | W | Re | Hf | Ti | Nb |
|---|---|---|---|---|---|---|---|---|---|---|---|---|
| PWA 1422 | DS | Bal. | 10 | 9 | 5 | — | — | 12 | — | 1.6 | 2 | 1 |
| DS R80H | DS | Bal. | 9.5 | 14 | 3 | 4 | — | 4 | — | 0.75 | 4.8 | — |
| CM247LC | DS | Bal. | 9.2 | 8.1 | 5.6 | 0.5 | 3.2 | 9.5 | — | 1.4 | 0.7 | — |
| PWA 1480 | SC | Bal. | 5 | 10 | 5 | — | 12 | 4 | — | — | 1.5 | — |
| PWA 1484 | SC | Bal. | 10 | 5 | 5.65 | 1.9 | 8.7 | 5.9 | 3 | 0.1 | — | — |
| Rene' N5 | SC | Bal. | 7.5 | 7 | 6.2 | 1.5 | 6.5 | 5 | 3 | 0.15 | — | — |
| CMSX-4 | SC | Bal. | 9 | 6.5 | 5.6 | 0.6 | 6.5 | 6 | 3 | 0.1 | 1 | — |

It was discovered that the alkali and alkaline earth sulfate salts responsible for elevated temperature corrosion of turbine components (varying mixtures of sodium, potassium, calcium and magnesium sulfates) can accumulate on regions of the blade outside of the turbine gas path. These salts can be ingested with the inlet air in marine environments and/or form as a result of combustion processes. Corrosion attack of the blade by these salts is typically very limited at temperatures below the salt melting temperature (about 1100 F.). With increased turbine operating temperature, however, blade regions shielded from the gas path can exceed the melting temperature of the sulfate salt resulting in accelerated corrosion of the blade neck and underside of the platform. It was also discovered that at sufficiently high stress levels, the presence of these salts may result in stress corrosion cracking of directionally solidified nickel-based turbine alloys having a single crystal or columnar grain structure. Stress corrosion cracking of these materials represents a newly discovered phenomenon.

In one aspect of the current invention, a corrosion-resistant overlay coating (21 in FIG. 1a) is applied to portions of the substrate 20 susceptible to stress corrosion, such as the underside of the platform 18 and the neck 19 of a turbine blade to prevent corrosion and/or stress corrosion cracking of the blade in these locations. While the present invention is illustrated in FIG. 1 as a turbine blade, the present invention is not intended to be limited to any particular component, but rather extends to any component which may be subject to stress corrosion cracking. Other components exposed to relatively high stress and corrosive conditions would also be expected to benefit from this invention.

The overlay coating applied to the under-platform surface 18 and 19 is preferably an MCrAlY coating, where M is cobalt, nickel, iron or combinations of these materials, although other overlay coatings such as MCr and MCrAl coatings may also be employed. Exemplary coatings useful with the present invention include at least NiCrAlY, CoCrAlY, NiCoCrAlY and CoNiCrAlY coatings. The coating may also include other elements such as Hf and Si to provide further improvements in oxidation or corrosion resistance. MCrAlY overlay coatings for applications to regions under the blade platform should have a composition (given in wt %) in the range of about 10-40% Cr, 5-35% Al, 0-2% Y, 0-7% Si, 0-2% Hf, with the balance consisting of a combination of Ni and/or Co. Preferred MCrAlY compositions would contain 20-40% Cr, 5-20% Al, 0-1% Y, 0-2% Si, and 0-1% Hf (balance Ni and/or Co). Exemplary coatings for optimum corrosion resistance should possess 25-40% Cr, 5-15% Al, 0-0.8Y, 0-0.5% Si, and 0-0.4% Hf with the balance comprised of Ni and/or Co. Each of these coatings may also include up to about 20 wt. % of other alloying elements. A summary of typical, preferred and exemplary overlay coating compositions is shown in Table 2.

TABLE 2
COMPOSITION OF PROTECTIVE COATINGS (wt %)

| | Coating Composition (wt %) | | | | | | |
|---|---|---|---|---|---|---|---|
| Specified Range | Ni | Co | Cr | Al | Y | Si | Hf |

| | | | | | | |
|---|---|---|---|---|---|---|
| Typical | Bal. | 10-40 | 5-35 | 0-2 | 0-7 | 0-2 |
| Preferred | Bal. | 20-40 | 5-20 | 0-1 | 0-2 | 0-1 |
| Exemplary | Bal. | 25-40 | 5-15 | 0-0.8 | 0-0.5 | 0-0.4 |

The coating is applied to the blade under-platform and neck to a maximum thickness of about 0.005″ (˜125 μm). For rotating applications, such as turbine blades, the coating thickness should be adequate to ensure complete coverage of the area to be coated and provide corrosion life necessary for providing protection for a typical blade service interval. The maximum coating thickness is limited due to the fatigue debit associated with the presence of a coating. The coating should be thick enough to ensure that all areas to be covered are covered, as some amount of thickness variation occurs in every coating process. Accordingly, the thickness for rotating components should be less than 0.005″ (between about 0.003-0.005″), preferably less than about 0.003″ (˜75 μm) and greater than 0.0005″ (12.5 μm), and more preferably about 0.002″ (˜50 μm).

The overlay coating may be applied by various processes known to those skilled in the art, such as by vapor deposition (including electron beam physical vapor deposition, sputtering, etc.) or thermal spray (air plasma spray, low pressure or vacuum plasma spray, high velocity oxy-fuel, etc.). Coating application by cathodic arc deposition was used to demonstrate this invention. This method is preferred to the extent that it provides enhanced thickness control of deposited coatings. An exemplary cathodic arc deposition apparatus for applying the coating is described in commonly owned and co-pending application Ser. No. 08/919,129, filed on Aug. 30, 1997 and entitled “Cathodic Arc Vapor Deposition Apparatus” which is expressly incorporated by reference herein.

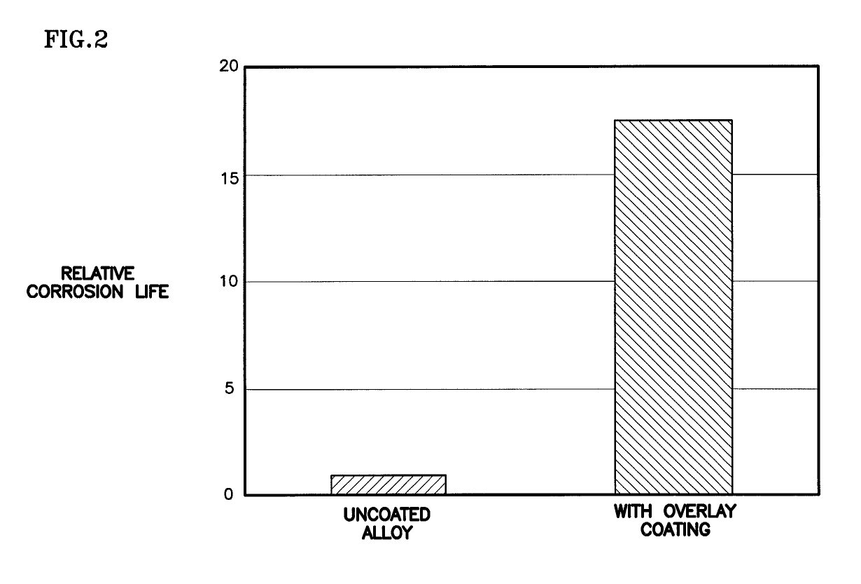

FIG. 2 illustrates the corrosion life improvement achieved through application of coatings disclosed in this invention. The under-platform surface of a single crystal turbine blade was coated with an exemplary MCrAlY coating comprised of about 35 wt. % Cr, 8 wt. % Al, 0.6 Y, 0.4 wt. % Si and 0.25 wt. % Hf, balance nickel. Corrosion testing of the coated blade at 1350° F. in the presence of sulfate salt showed a 5-20× improvement in corrosion life relative to the uncoated blade as measured by the relative depths of corrosion attack. Application of the same corrosion resistant overlay coating to test specimens was also shown to prevent stress corrosion cracking of the single crystal alloy.

FIG. 3 represents an alternate embodiment of the present invention. The component includes a metallic substrate 20, e.g., a superalloy material, an aluminide (or platinum aluminide) layer 22 and an overlay coating 24 on the aluminide layer. Aluminide and platinum aluminide layers are known generally, and the particular composition and method of application is not described here in detail. See, e.g., U.S. Pat. No. 5,514,482. The aluminide or platinum aluminide layer may be present to provide the coating with some desired property, e.g., improved durability or may be preexisting, e.g., to enable more efficient blade repair/manufacture where the overlay coating is applied during repair or refurbishment of the component and a previously applied aluminide layer is not or is only partially removed as part of the repair or refurbishment.

FIG. 4 is another alternate embodiment of the present invention. The component (not shown in its entirety) includes a metallic substrate 26, e.g., a superalloy material, an overlay coating 24 on the substrate and an aluminide layer 30 on the overlay coating. The aluminide layer may be present, for example, to provide the coating with some desired property.

In many cases, a portion of the article subjected to high temperatures is also coated. In the case of turbine blades, the airfoil portion may be covered with a metallic overlay coating, Such as the types descried above, or with an aluminide coating, such as are described in the above '482 patent, or with a ceramic thermally insulating layer, or some combination of these coatings. In many cases, the airfoil portion will be coated with a coating having a composition different than applied to the underplatform and neck portions, and in other cases the compositions may be similar or the same. For example, the airfoil surface may be covered with an aluminide while the underplatform surface and neck may be coated with an MCrAlY overlay-type coating. Other combinations of coatings, of course, are also possible and the present invention is not intended to be limited to any particular combination of coatings on the exposed portion(s) and the shielded portion(s) of a component.

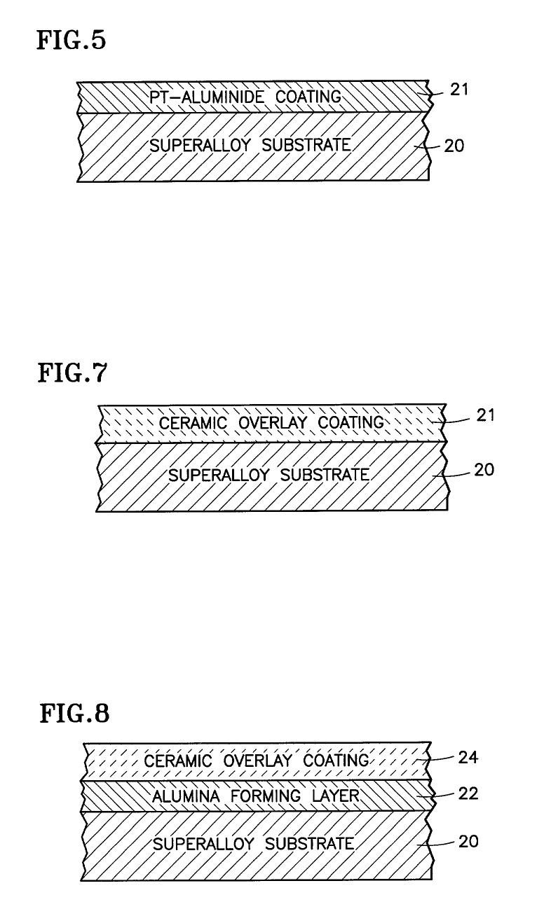

According to another aspect of the current invention, a corrosion-resistant noble metal containing aluminide coating (21 in FIG. 5) is applied to portions of the substrate 20 susceptible to stress corrosion, such as the underside of the platform 18 and the neck 19 of a turbine blade (for example similar to the blade described in FIG. 1 above) to prevent corrosion and/or stress corrosion cracking of the blade in these locations. The coating is preferably characterized by a single phase microstructure, e.g., a single phase of Pt, Al and Ni. While the present invention is illustrated in FIG. 5 as a turbine blade, the present invention is not limited to any particular component. Other components exposed to relatively high stress and corrosive conditions would also be expected to benefit from this invention.

In the illustrated embodiment of this invention, the coating applied to the under-platform surfaces 18 and 19 is preferably a platinum aluminide coating, containing between about 11-65 wt. % platinum, more preferably about 30-55 wt. % platinum and most preferably 30-45 wt. % platinum with the balance primarily aluminum and nickel. This composition is measured near the surface of the coating, e.g., not deeper than the outer 20% of the total coating thickness. Surprisingly, platinum aluminide coatings having lesser and greater amounts of the most preferred platinum level do not provide the desired level of protection against corrosion. Other noble metals in an aluminide coating, particularly palladium and rhodium, could also be employed, but platinum is presently preferred and as used herein is intended to include these other materials. The coating may also include other elements such as yttrium, hafnium and/or silicon to provide further improvements in oxidation or corrosion resistance. While the coating may be applied by various processes, we have used application of the platinum layer by plating, followed by an out-of-pack aluminizing process to cover and diffuse with the plated platinum layer, in the present illustration. The platinum may also be applied by sputtering or other suitable process, and the aluminum may be deposited by in-pack processes or by vapor deposition with other suitable processes. The out-of-pack aluminizing process is typically also used to coat internal passages of components such as turbine blades and has also been used to coat the surfaces exposed to the primary turbine gas path, e.g., the airfoil surfaces.

By way of example, sample turbine blades were coated according to the present invention. The blades were composed of a nickel base superalloy having a nominal composition in weight percent of: 10 Co, 5 Cr, 5.65 Al, 1.9 Mo, 8.7 Ta, 5.9 W, 3 Re, 0.1 Hf, balance Ni. The underplatform surfaces, including the blade neck were plated with platinum by immersing those surfaces in a plating bath of hexachloroplatanic acid maintained at a temperature of about 165-180 F. (74-82° C.). Portions of the blade root are generally not plated, and other portions where plating is not desired may be masked. The plating time will depend upon the plating solution concentration and the the thickness of plating layer to be applied. For purposes of the present invention, we have used platinum layers having a thickness of between about 0.15-0.3 mils with good results, and we believe that substantially thicker or thinner layers may also be employed.

An aluminide layer is then applied to the desired portions of the article, including the plated portion. We have applied aluminides to these articles as described in commonly-owned U.S. Pat. Nos. 4,132,816 and 4,148,275 both to Benden et al. Such an aluminide process has been used for coating exterior and/or interior surfaces of airfoils. Other processes and equipment could also be used with equal effect. As a result, the coating on the airfoil surfaces is a simple aluminide while the coating on the surfaces subject to stress corrosion cracking has a different composition, i.e., a platinum aluminide.

The coating is applied to the under-platform surfaces to a thickness of up to about 0.005″ (5 mils), For rotating applications, such as turbine blades, the coating thickness should be adequate to ensure complete coverage of the area to be coated and enable corrosion life necessary for providing protection for a typical blade service interval. While thicker coatings may be used, there can be an associated fatigue debit, particularly for rotating components. The maximum coating thickness is limited due to the fatigue debit associated with the presence of a coating. Accordingly, the thickness for rotating components is preferably less than about 0.005″ (˜5 mils) and greater than 0.001″ (1 mil), and more preferably less than about 0.003″ (˜3 mils).

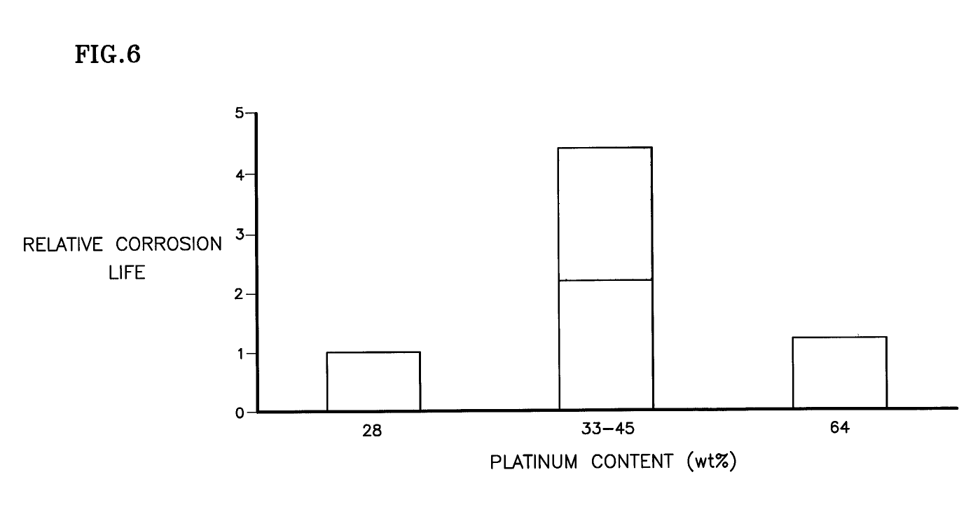

FIG. 6 illustrates the corrosion life improvement achieved through application of coatings disclosed in this invention. Corrosion testing of the coated blade with the preferred range of compositions at a generally constant temperature of 1350° F. in the presence of synthetic sea salt and SO₂ showed a 2-4× improvement in corrosion life relative to the uncoated blade. Application of the same coating to test specimens was also shown to prevent stress corrosion cracking.

In still another aspect of the current invention, a corrosion-resistant overlay coating (21 in FIG. 7) is applied to portions of the substrate 20 susceptible to stress corrosion, such as the underside of the platform 18 and the neck 19 of a turbine blade to prevent corrosion and/or stress corrosion cracking of the blade in these locations. While the present invention is illustrated in FIG. 7 as a turbine blade, the present invention is not limited to any particular component. Other components exposed to relatively high stress and corrosive conditions would also be expected to benefit from this invention.

Referring now to FIG. 7, a corrosion inhibiting, ceramic coating is applied to a portion or portions of the article that are susceptible to corrosion and/or stress corrosion cracking. Using the turbine blade example, the coating is applied to the underside of the platform 18 and the neck 19 to prevent corrosion and/or stress corrosion cracking of the blade in these locations. Other components exposed to relatively high stress and corrosive conditions would also be expected to benefit from this invention. The overlay coating applied to the selected area(s), e.g., the under-platform surface 18 and neck 19 may be a conventional thermal barrier coating type material, such as a stabilized zirconia, e.g., 7YSZ, although the coating may also include other elements. We believe that other ceramic coatings may be employed with equal effect.

The coating is applied to the surface(s) to a thickness of at least about 0.25 mils and up to about 5 mils. For rotating applications, such as turbine blades, the coating thickness should be adequate to ensure complete coverage of the area to be coated, e.g., no bare spots, and provide corrosion life necessary for providing protection for a typical blade service interval. The maximum coating thickness should be limited due to the fatigue debit associated with the additional weight of coatings, which typically add no structural strength to the article. Accordingly, the thickness for rotating components is preferably less than about 3 mils, and more preferably about 2 mils.

The overlay coating may be applied by various processes, such as by vapor deposition or thermal spray. We prefer to use a plasma spray, which has been used previously to apply ceramic materials to other portions of gas turbine engine components such as the airfoil portions.

FIG. 8 is an alternate embodiment of the invention illustrated in FIG. 7. The component includes an alumna forming coating between the ceramic layer and the substrate. For example, the component may include a substrate 20 as above, an alumina forming layer 2, such as an MCrAl type overlay coating or an aluminide layer. Both MCrAI coatings, which may include other elements such as Y, Hf, Si, Re and others, and aluminide coatings are known generally, and the particular NtMCrAl and aluminide compositions and methods of application need not be described here in detail. See, e.g., commonly owned U.S. Pat. No. Re 32,121 for a discussion of MCrAlY coatings and 5,514,482 for a description of aluminide layers, both of which are expressly incorporated by reference herein. As is the case with the ceramic coating, the alumina forming layer adds weight but not structural strength to the article being coated, and should be no thicker than necessary. The ceramic, such as 7YSZ may then be applied by any suitable process, such as thermal spray or physical vapor deposition.

The present invention provides significant improvements in durability over the prior art. Field experience has shown that blades without coating in these areas can be subject to severe corrosion damage during service. Application of a metallic overlay coating of the preferred compositions on selected portions of an article subjected to high temperatures, such as the under-platform surface and neck of a turbine blade, provides superior corrosion and stress corrosion cracking protection during operation.

While the present invention has been described above in some detail, numerous variations and substitutions may be made without departing from the spirit of the invention or the scope of the following claims. Accordingly, it is to be understood that the invention has been in described by way of illustration and not by limitation.

What is claimed is:

1. A method of improving the durability of a turbine blade composed of a superalloy material and defining an airfoil, a root, a neck, and a platform located between the airfoil and root, the platform has an underside adjacent the neck, comprising the steps of:
providing a superalloy substrate; and
applying a corrosion resistant overlay coating to the underside of the platform and blade neck.

2. The method of claim 1, wherein the coating applied is an MCrAlY overlay coating (M representing combinations of Ni, Co and/or Fe).

3. The method of claim 1, wherein the coating contains 10-40% Cr, 5-35% Al, 0-2% Y, 0-7% Si, 0-2% Hf, balance primarily Ni and/or Co with all other elemental additions comprising <20% of the total.

4. The method of claim 1, wherein the coating contains 20-40% Cr, 5-20% Al, 0-1% Y, 0-2% Si, 0-1% Hf; balance primarily Ni and/or Co with all other elemental additions comprising <20% of the total.

5. The method of claim 1, wherein the coating contains 25-40% Cr, 5-l 5% Al, 0-0.8% Y, 0-0.05% Si, 0-0.4% Hf, balance primarily Ni and/or Co with all other elemental additions comprising <20% of the total.

6. The method of claim 1, wherein the coating is applied to a nominal thickness of less than about 0.005″.

7. The method of claim 1, wherein the coating is applied to a thickness between about 0.0005-0.003″.

8. The method of claim 1, further comprising the step of applying another coating on the airfoil surface.

9. The method of claim 8, wherein the composition of the another coating being different than the corrosion resistant overlay coating.

10. The method of claim 1, further comprising: an aluminide layer on the substrate surface, the overlay coating on the aluminide layer.

11. The method of claim 1, further comprising an aluminide layer located on the overlay coating.

12. The method of claim 1, wherein the step of providing a substrate includes providing a substrate comprised of an equiaxed nickel-based alloy, a directionally solidified nickel-based alloy, a single crystal nickel-based alloy or a columnar grain nickel-based alloy.

13. The method of claim 1, wherein the step of applying the coating is performed by cathodic arc, thermal spray, vapor deposition or sputtering.

14. A method of improving the durability of a superalloy gas turbine component which operates in an environment with primary gas path temperatures in excess of 1000°C., The method having a first, exposed portion which is directly exposed to hot gas path, a second, shielded section which is shielded from direct exposure to the hot gas path, and a third section between the exposed and shielded portions, the improvement which comprises applying a corrosion resistant overlay coating applied to the third section.

15. The method of claim 14 wherein the component comprises a turbine blade, the first portion forming an airfoil, the airfoil covered by a first coating, the second portion forming a root, and the third section forming a platform and neck, the improvement comprising a corrosion resistant coating applied to the underside of the platform and neck.

16. The method of claim 14, further comprising the step of applying another coating on the airfoil surface.

17. The method of claim 18, the composition of the another coating being different than the corrosion resistant overlay coating.

18. The method of claim 14, wherein the step of applying includes applying an MCrAlY coating (M representing combinations of Ni, Co and/or Fe).

19. The method of claim 14, wherein the coating in weight percent contains 10-40% Cr, 5-35% Al, 0-2% Y, 0-7% Si, 0-2% Hf, balance primarily Ni and/or Co with all other elemental additions comprising about <20% of the total.

20. The method of claim 14, wherein the coating contains 25-40% Cr, 5-15% Al, 0-0.8% Y, 0-0.5% Si, 0-0.4% Hf, balance primarily Ni and/or Co with all other elemental additions comprising about <20% of the total.

21. The method of claim 14, wherein the coating has a nominal thickness of less than about 0.005″.

22. The method of claim 14, wherein the step of applying the coating is performed by cathodic arc, thermal spray, vapor deposition or sputtering.

23. A method of improving the durability of a turbine blade composed of a superalloy material and defining an airfoil, a root, a neck, and a platform located between the airfoil and root, the platform has an underside adjacent the neck, comprising the steps of:
providing a superalloy substrate; and
applying a corrosion resistant noble metal-containing aluminide coating on the underside of the platform and blade neck.

24. The method of claim 23, wherein the step of applying an aluminide coating includes applying a platinum aluminide coating.

25. The method of claim 23, wherein the coating contains about 11-60 wt. % platinum, balance aluminum.

26. The method of claim 23, wherein the coating contains about 25-55 wt. % platinum, balance aluminum.

27. The method of claim 23, wherein the coating contains about 30-45 wt. % platinum, balance aluminum.

28. The method of claim 23, wherein the coating has a nominal thickness of less than about 0.005″.

29. The method of claim 23, further comprising the step of applying another coating on the airfoil surface.

30. The method of claim 29, the composition of the another coating being different than the corrosion resistant noble metal containing aluminide coating.

31. The method of claim 23, wherein the step of applying the coating is performed by electroplating the noble metal onto the substrate; and
aluminizing the substrate.

32. A method of improving the durability of a superalloy gas turbine component which operates in an environment with primary gas path temperatures in excess of 100020 C., the component having a first, exposed portion which is directly exposed to hot gas path, a second, shielded section which is shielded from direct exposure to the hot gas path, and a third section between the exposed and shielded portions, the improvement which comprises applying a corrosion resistant aluminide coating applied to the third section.

33. The component of claim 32 comprising a turbine blade, the first portion forming an airfoil, the section portion forming a root, and the third section forming a platform, the improvement comprising a corrosion resistant coatings applied to the underside of the platform.

34. The method of claim 32, further comprising the step of applying another coating on the airfoil surface.

35. The method of claim 32, wherein the step of applying another coating, includes applying another coating having a composition different than the noble metal containing aluminide coating.

36. The method of claim 32, wherein the coating further comprises yttrium, hafnium and/or silicon.

37. A method of improving the durability of a turbine blade composed of a superalloy material and defining an airfoil, a root, a neck, and a platform located between the airfoil and root, the platform has an underside adjacent the neck, comprising the steps of:
providing a superalloy substrate; and
applying a corrosion inhibiting, ceramic overlay coating on the underside of the platform.

38. The method of claim 37, wherein the ceramic coating is composed of stabilized zirconia.

39. The method of claim 37, wherein the ceramic is applied by vapor deposition, thermal spray, or sputtering.

40. The method of claim 37, wherein the ceramic coating is applied to a nominal thickness of less than about 5 mils.

41. The method of claim 37, wherein the step of applying includes forming an alumina layer on the substrate surface, the ceramic coating on the alumina layer.

42. The method of claim 37, wherein the alumina layer is formed from an aluminide or overlay bond coat applied to the substrate.

43. The method of claim 37, further comprising the step of applying another coating on the airfoil surface.

44. The method of claim 43, wherein the step of applying another coating includes applying another coating having a composition different than the ceramic coating.

45. A method of improving the durability of a superalloy gas turbine component which operates in an environment with primary gas path temperatures in excess of 1000° C., the component having a first, exposed portion which is directly exposed to hot gas path, a second, shielded section which is shielded from direct exposure to the hot gas path, and a third section between the exposed and shielded portions, the improvement which comprises applying a corrosion resistant corrosion inhibiting ceramic coating applied to the third section.

46. The method of claim 45 comprising a turbine blade, the first portion forming an airfoil, the section portion forming a root, and the third section forming a platform, the improvement comprising a corrosion resistant coating applied to the underside of the platform.

47. The method of claim 45, wherein the ceramic coating is composed of stabilized zirconia.

48. The method of claim 45, wherein the ceramic is applied by vapor deposition, thermal spray, or sputtering.

49. The method of claim 45, wherein the ceramic coating is applied to a nominal thickness of less than about 5 mils.

50. The method of claim 45, wherein the step of applying includes forming an alumina layer on the substrate surface, the ceramic coating on the alumina layer.

51. The method of claim 45, wherein the alumina layer is formed from an aluminide or overlay bond coat applied to the substrate.

52. The method of claim 45, further comprising the step of applying another coating on the airfoil surface.

53. The method of claim 52, wherein the step of applying another coating includes applying another coating having a composition different than the ceramic coating.
